(19) United States
(12) Patent Application Publication
(10) Pub. No.: US 2014/0311597 A1
(43) Pub. Date: Oct. 23, 2014

(54) Compact Fuel Pressure Regulator

(71) Applicant: CONTINENTAL AUTOMOTIVE SYSTEMS, INC., Auburn Hills, MI (US)

(72) Inventors: Spencer Paul Mooney, Newport News, VA (US); Joseph Kevin Cecelic, Williamsburg, VA (US); Matthew Shaun Liwanag, Newport News, VA (US); Saul Abelardo Pena De Santiago, Williamsburg, VA (US); Harish Domala, Williamsburg, VA (US)

(73) Assignee: Continental Automotive Systems, Inc., Auburn Hills, MI (US)

(21) Appl. No.: 13/864,511

(22) Filed: Apr. 17, 2013

(51) Int. Cl. F02M 63/00

(52) U.S. Cl. CPC F02M 63/0054
USPC 137/539.5

(57) ABSTRACT

A flow-through pressure regulator includes housing structure having a fuel inlet and a fuel outlet. A seal band is defined by the housing structure. A valve element is movable between open and closed positions. The valve element has a sealing surface that engages the seal band in the closed position to prevent fuel from passing from the fuel inlet to the fuel outlet. A compression spring is disposed in the housing structure. The spring is constructed and arranged to bias the valve element to the closed position in opposition to pressure exerted on the valve element by fuel at the fuel inlet. A guide member is associated with the valve element and is constructed and arranged to align the valve element with respect to the seal band. A calibration member is associated with an end of the spring and is constructed and arranged to pre-set compression of the spring.

### FIELD

The invention relates to fuel supply systems and, more particularly, to a compact flow-through fuel pressure regulator for controlling the pressure of fuel within the fuel system.

### BACKGROUND

Most modem automotive fuel systems use fuel injectors to deliver fuel to the engine cylinders for combustion. The fuel injectors are mounted on a fuel rail to which fuel is supplied by a fuel pump. The pressure at which the fuel is supplied to the fuel rail must be metered to ensure the proper operation of the fuel injector. Metering is carried out by using a pressure regulator that controls the pressure of the fuel in the system at all engine RPM levels.

Conventional flow-through fuel pressure regulators typically include diaphragms. While such pressure regulators have been proven satisfactory, they require either a great number of parts or large parts and thus do not have a small packaging envelope.

Thus, there is a need to provide an improved fuel pressure regulator with fewer and smaller parts than conventional regulators to reduce the material, manufacturing costs thereof, and packaging envelope.

### SUMMARY

An object of the present invention is to fulfill the need referred to above. In accordance with the principles of an embodiment, this objective is obtained by a flow-through pressure regulator that includes housing structure having a fuel inlet and a fuel outlet. A seal band is defined by the housing structure. A valve element is movable between open and closed positions. The valve element has a sealing surface that engages the seal band in the closed position to prevent fuel from passing from the fuel inlet to the fuel outlet. A compression spring is disposed in the housing structure. The spring is constructed and arranged to bias the valve element to the closed position in opposition to pressure exerted on the valve element by fuel at the fuel inlet. A guide member is associated with the valve element and is constructed and arranged to align the valve element with respect to the seal band. A calibration member is associated with an end of the spring and is constructed and arranged to pre-set compression of the spring.

In accordance with another aspect of an embodiment, a flow-through pressure regulator includes housing structure having a fuel inlet and a fuel outlet. A seal band is defined by the housing structure. A valve element is movable between open and closed positions. The valve element has a sealing surface that engages the seal band in the closed position to prevent fuel from passing from the fuel inlet to the fuel outlet. A compression spring is disposed in the housing structure. The spring is constructed and arranged to bias the valve element to the closed position in opposition to pressure exerted on the valve element by fuel at the fuel inlet. Means, associated with the valve element, are provided for aligning the valve element with respect to the seal band. Means, associated with an end of the spring, are provided for pre-setting a compression of the spring.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a sectional view of a fuel pressure regulator provided in accordance with an embodiment of the present invention.

FIG. 2 is a front view of a fuel pressure regulator provided in accordance with another embodiment of the present invention

FIG. 3 is a sectional view taken along the line 3-3 in FIG. 2.

FIG. 4 is a front view of a fuel pressure regulator provided in accordance with yet another embodiment of the present invention

FIG. 5 is a sectional view taken along the line 5-5 in FIG. 4.

FIG. 6 is a front view of a fuel pressure regulator provided in accordance with still another embodiment of the present invention

FIG. 7 is a sectional view taken along the line 7-7 in FIG. 6.

### DETAILED DESCRIPTION OF THE EXEMPLARY EMBODIMENTS

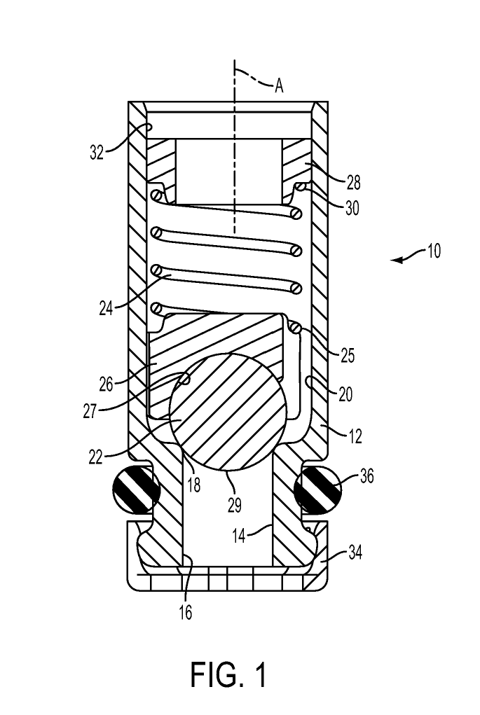

Referring to FIG. 1, a fuel pressure regulator is shown in section, generally indicated at 10, in accordance with an embodiment of the present invention. The regulator 10 is preferably used in automotive fuel systems, particularly in fuel delivery modules. The regulator 10 includes a generally cylindrical fuel housing structure 12 defining a fuel chamber 14 that receives fuel that enters a fuel inlet 16 of the housing structure 12 delivered by a fuel pump (not shown). The housing structure 12 includes a valve seat or seal band 18 defined at a transition from the smaller diameter fuel chamber 14 to a larger diameter spring chamber 20 of the housing structure 12. The valve seat 18 cooperates with a valve element 22, preferably in the form of a spherical member.

The seal band 18 is an annular surface area that is characterized by a surface finish with a minimal amount of leak paths. The metal seal band 18 provides a uniform surface for the metal valve element 22 to selectively interact with the housing structure 12. By achieving contact across the entire seal band 18 a liquid-tight seal is achieved. The seal band 18 is preferably a concave annular surface, coined into the housing structure 12 by a forming member or by the valve element 22.

The fuel pressure regulator 10 includes a compression spring 24, preferably a coil spring, that has one end 25 engaging a guide member 26. The spring 24 provides an acting force upon the guide member 26 that engages the valve element 22. The spring force (load) is transferred onto the valve element 22 via engagement with a concave surface 27 of the guide member 26 so that the convex sealing surface 29 of the valve element 22 engages and thus mates with the concave annular surface of the seal band 18 in a closed position of the valve element 22, thereby preventing fuel flow past the seal band 18. The guide member 26 maintains the valve element 22 aligned within the housing structure 12. The valve element 22 can be separate from or encapsulated with the guide member 26. Other methods used to achieve alignment of the valve element 22 and the seal band 18 can include the addition of a lower guide (not shown) that constrains lateral movement of the valve element 22 which may be located at the equator of the spherical valve element 22.

A calibration member or cap 28 is provided in the housing 12 and engages a second end 30 of the spring 24. The calibration cap 28 and the guide member 26 provide locating or centering features for the compression spring 24. Calibration of the fuel pressure regulator 10 is achieved by pre-setting the compression of the spring 24 via a calibration cap 28 that has a press fit, or other similar methods of assembly, with the housing structure 12 at the fuel outlet 32. The housing 12, valve element 22, spring 24, guide member 26 and calibration cap 28 are aligned along a common axis A.

The fuel pressure is maintained at a predetermined level by balancing the force the fuel is exerting on the spring loaded valve element 22 at a predetermined flow rate. Fuel is delivered to the inlet 14 through a filter 34 where the applied pressure causes the valve element 22 to lift off the seal band 18 allowing fuel to pass through the inlet 14 and around the valve element 22. The fuel then is channeled to the outside through the outlet 32 of the housing structure 12. A seal structure for sealing the regulator 10 to a fuel delivery module (not shown) includes an O-ring 36 or similar connection methods including, but not restricted to, press-fits and barbed surface features on the housing structure 12.

Instead of providing a unitary housing structure 12 as in FIG. 1, with reference to

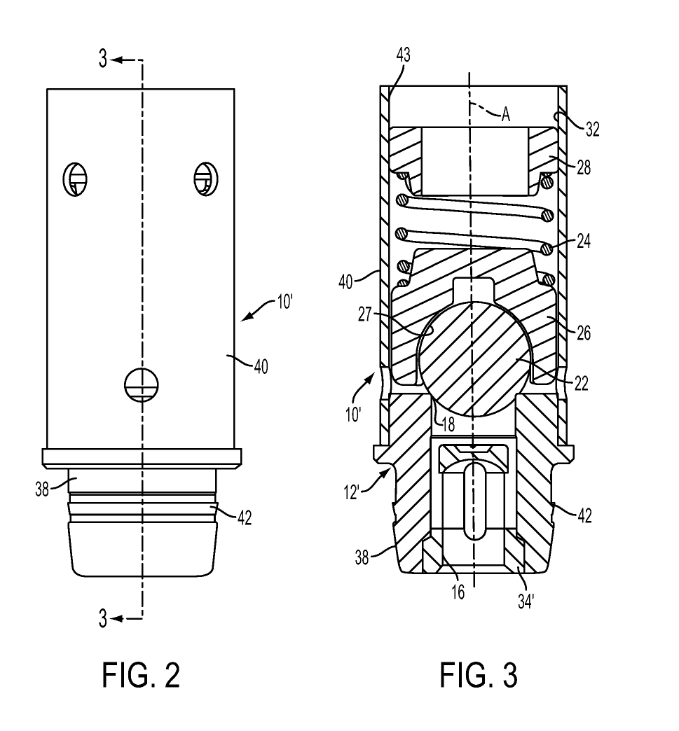

FIGS. 2 and 3, the housing structure, generally indicated at 12′, of regulator 10′ may be comprised of a body 38 coupled to a tube 40 via press fit, welding or via a threaded shaft. Furthermore, the seal band 18 is part of the body 38 and the body 38 includes a barbed fitting 42 in place of the O-ring 36 of FIG. 1. The filter 34′ is provided internally of the body 38. The tube 40 has an opened end 43 with the calibration cap 28 being disposed, preferably in press-fit relation, with the opened end 43.

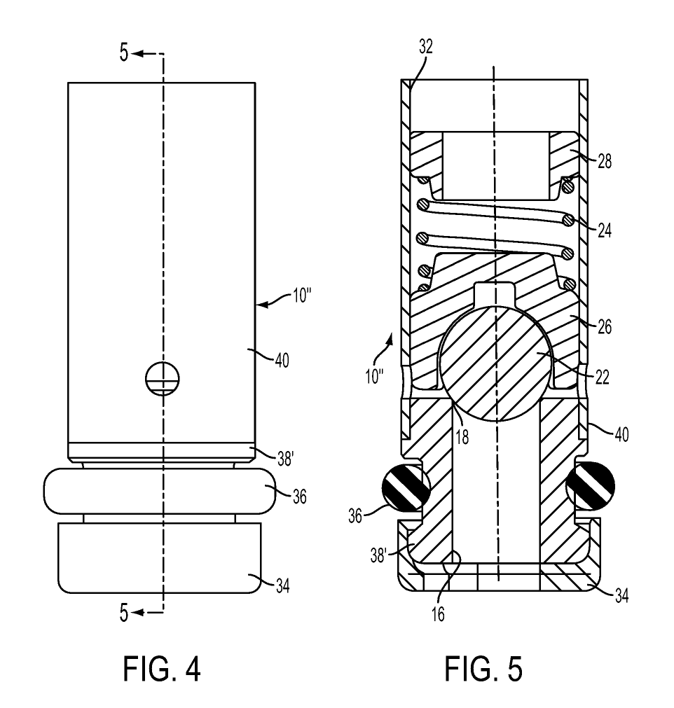

FIGS. 4 and 5 show another embodiment of the pressure regulator 10″ with the body 38′ coupled to the tube 40 as in FIGS. 2 and 3. However, the regulator 10″ uses the O-ring 36 for sealing to the fuel delivery module (not shown) and for easy removal there-from. The regulator 10″ also uses the external filter 34.

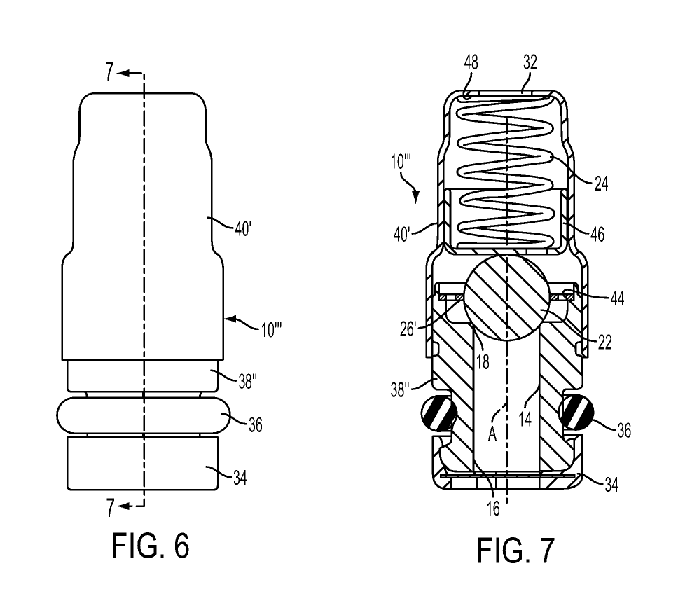

FIGS. 6 and 7 show yet another embodiment of the fuel pressure regulator 10′″ with the body 38″ coupled to a cover 40′ similar to FIGS. 2 and 3. However, the body 38″ includes a lower guide member 26′ attached thereto that is used to maintain alignment of the valve element 22 with the seal band 18. The guide member 26′ has passages 44 so that fuel may pass there-through. The force of spring 24 is applied to the valve element 22 directly or through a spring cup 46 that maintains the spring 24 axially aligned, as shown. The desired calibration is achieved by press-fitting the cover 40′ to the body 38″ to pre-set the compression of the spring 24. Thus, closed end 48 of the cover 40′ defines the calibration member when the cover 40′ is fixed to the body 38″. This assembly compresses the spring 24 to deliver the required force for the particular calibration.

The pressure regulators 10, 10′, 10″ and 10′″ do not require an elastomer diaphragm. Furthermore, the regulators use a compact, simple coil spring instead of the large disk springs of conventional regulators and thus are more compact and less expensive to manufacture than conventional regulators.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A flow-through pressure regulator comprising:
housing structure having a fuel inlet and a fuel outlet,
a seal band defined by the housing structure,
a valve element movable between open and closed positions, the valve element having a sealing surface that engages the seal band in the closed position to prevent fuel from passing from the fuel inlet to the fuel outlet,
a compression spring disposed in the housing structure, the spring being constructed and arranged to bias the valve element to the closed position in opposition to pressure exerted on the valve element by fuel at the fuel inlet,
a guide member associated with the valve element and constructed and arranged to align the valve element with respect to the seal band, and
a calibration member associated with an end of the spring and constructed and arranged to pre-set compression of the spring.

2. The regulator of claim 1, wherein the valve element, spring, guide member and calibration member are aligned along a common axis.

3. The regulator of claim 1, wherein the valve element is a metal spherical member and the seal band is a metal, annular, convex surface.

4. The regulator of claim 3, wherein the spring is a coil spring having first and second ends, and wherein the guide member is engaged with the first end of the spring and the calibration member is engaged with the second end of the spring.

5. The regulator of claim 3, wherein the valve element is a spherical member and the guide member includes a concave surface engaging the valve element.

6. The regulator of claim 1, wherein the housing structure is of unitary construction.

7. The regulator of claim 1, wherein the housing structure includes seal structure constructed and arranged to seal the regulator with respect to a fuel delivery module.

8. The regulator of claim 7, wherein the seal structure includes an O-ring mounted on the housing structure or a barb surface feature on the housing structure.

9. The regulator of claim 1, wherein the housing structure includes a body coupled to a tube having an opened end, the seal band being part of the body and the calibration member being disposed in the opened end of the tube.

10. The regulator of claim 1, wherein the housing structure includes a body coupled to a cover having a closed end, the seal band being part of the body and the closed end of the cover defining the calibration member.

11. The regulator of claim 10, wherein the guide member is coupled to the body and the regulator further comprises a spring cup associated with a first end of the spring.

12. A flow-through pressure regulator comprising:
housing structure having a fuel inlet and a fuel outlet,
a seal band defined by the housing structure,
a valve element movable between open and closed positions, the valve element having a sealing surface that engages the seal band in the closed position to prevent fuel from passing from the fuel inlet to the fuel outlet,
a compression spring disposed in the housing structure, the spring being constructed and arranged to bias the valve element to the closed position in opposition to pressure exerted on the valve element by fuel at the fuel inlet,
means, associated with the valve element, for aligning the valve element with respect to the seal band, and
means, associated with an end of the spring, for pre-setting a compression of the spring.

13. The regulator of claim 12, wherein the valve element, spring, means for aligning and the means for pre-setting are aligned along a common axis.

14. The regulator of claim 12, wherein the spring is a coil spring having first and second ends, and wherein the means for aligning is engaged with the first end of the spring and the means for pre-setting is engaged with the second end of the spring.

15. The regulator of claim 12, wherein the valve element is a spherical member and the means for aligning includes a concave surface engaging the valve element.

16. The regulator of claim 12, wherein the housing structure includes seal structure constructed and arranged to seal the regulator with respect to a fuel delivery module.

17. The regulator of claim 16, wherein the seal structure includes an O-ring mounted on the housing structure or a barb surface feature on the housing structure.

18. The regulator of claim 12, wherein the housing structure includes a body coupled to a tube having an opened end, the seal band being part of the body and the means for pre-setting being disposed in the opened end of the tube.

19. The regulator of claim 12, wherein the housing structure includes a body coupled to a cover having a closed end, the seal band being part of the body and the closed end of the cover defining the means for pre-setting.

20. The regulator of claim 19, wherein the means for aligning is coupled to the body and the regulator further comprises a spring cup associated with a first end of the spring.
